(19) United States
(12) Patent Application Publication
(10) Pub. No.: US 2009/0052721 A1
(43) Pub. Date: Feb. 26, 2009

(54) COMBINED INDUCTIVE CHARGING COIL AND AUDIO SPEAKER FOR USE IN A PERSONAL CARE APPLIANCE

(75) Inventor: Christopher J. Dabrowski, Lynnwood, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,283

(22) PCT Filed: Dec. 14, 2006
(86) PCT No.: PCT/IB2006/054870

§ 371 Date: Sep. 10, 2008

Related U.S. Application Data
(60) Provisional application No. 60/752,651, filed on Dec. 21, 2005.

(51) Int. Cl. H04R 1/02

(52) U.S. Cl. 381/386

(57) ABSTRACT

The combined charge coil and audio speaker coil assembly (30) includes a single coil (32) which acts as a charging coil for a battery charging circuit and as an audio speaker coil, in a personal care appliance. An audio speaker membrane (42) is mounted to produce audio sounds when activated. A magnet (40) is included for the audio speaker and the single coil is mounted to the speaker membrane for driving the membrane in response to a drive signal. Electrical con- tact members (50, 52) for the coil are connected to receive a driving signal to move the membrane to produce an audio sound and to a recharging circuit (34) for recharging of the appliance batteries (16).

This invention relates to personal care appliances, such as a power toothbrush, the power toothbrush including a coil for recharging the batteries within the appliance and a separate coil for an audio speaker for the appliance.

Personal care appliances, including, for instance, power toothbrushes, are being packaged into smaller configurations/arrangements while generally retaining the same overall functionality. This typically requires reduction of component size and/or creative component layout. The total number of components required, however, places a lower limit on the size and a limit on the form of the appliance, if overall functionality is to be maintained. However, the benefits of a smaller size, in order to reduce costs, and component layout are important considerations in design approaches for personal care appliances.

Accordingly, the present invention is a combined charge coil and audio speaker coil assembly in a personal care appliance, comprising: a single coil for inductively receiving charging current from a charger and for use in an audio speaker arrangement; an audio speaker membrane mounted to produce audio sounds when activated; a magnet for use in said audio speaker arrangement, wherein the single coil and the magnet are mounted such that the speaker membrane moves to produce an audible sound when a driving signal is applied to the coil; and contact members connected by leads to the coil for receiving said driving signal to move the membrane to produce an audio sound and also connected to a charging circuit for the rechargeable batteries.

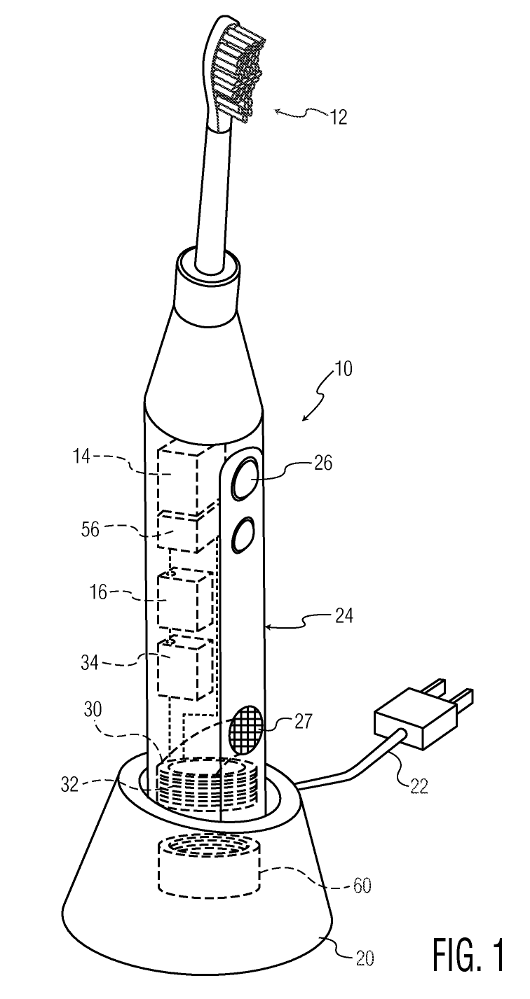

FIG. 1 is a diagram showing the combined charge coil and audio speaker assembly with audio coil in a power toothbrush.

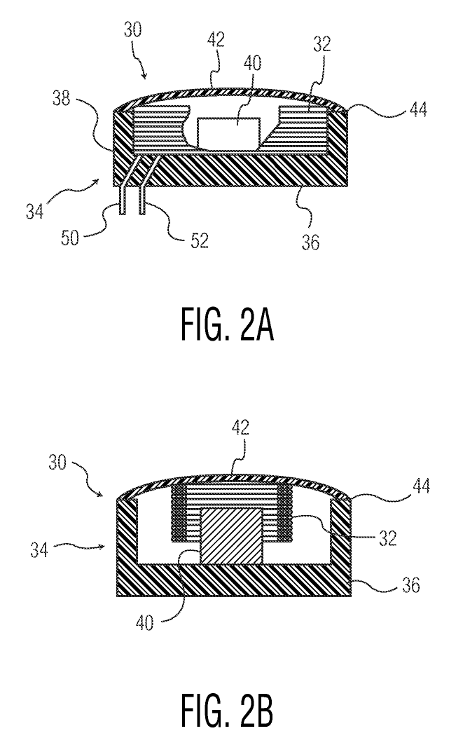

FIG. 2A is an elevational view showing the combined charge coil and audio speaker coil in a more detailed form.

FIG. 2B is a cross-sectional view of an assembly similar to FIG. 2A, with a slightly modified coil configuration.

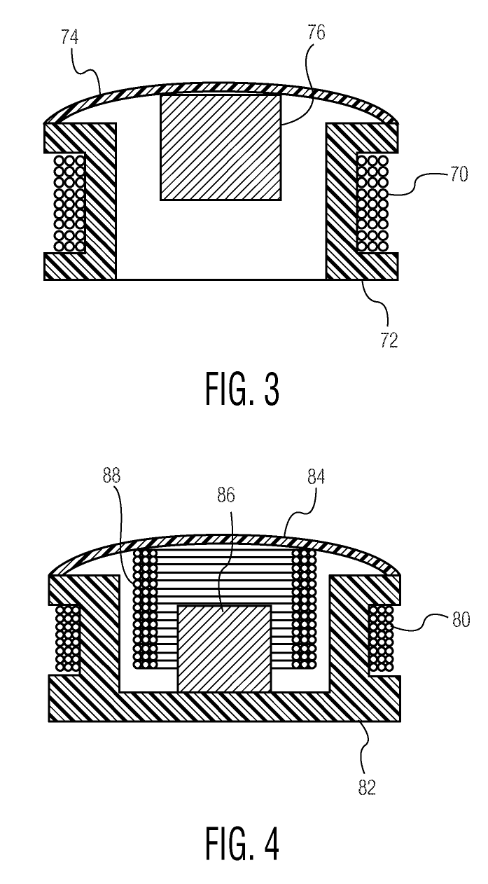

FIGS. 3 and 4 are cross-sectional views of alternative arrangements for the assembly of FIGS. 2A and 2B.

FIG. 1 shows a power toothbrush, generally at 10. The power toothbrush includes a brushhead 12 which vibrates under the control of a drive system 14, driven by rechargeable batteries 16. The drive system 14 can be any one of various known drive systems. One example is shown in U.S. Pat. No. 5,378,153, owned by the assignee of the present invention. However, other drive systems can be used. The toothbrush is controlled in operation by a microprocessor, shown at 56. The power toothbrush, when not in use, sits in a charger 20, which is connectable to an electrical power outlet by a power cord 22. Power toothbrush 10 includes a user interface panel 24 which, among other controls, will include an ON/OFF switch 26. The power toothbrush 10 also includes an audio speaker arrangement for communication with the user, either by pre-recorded messages, various tones or music, or other audio information. A speaker grill is shown at 27 for illustration. The speaker assembly is within the toothbrush.

The present invention is a combined charging coil and speaker coil assembly, generally shown at 30, referred to hereinafter as a combined coil assembly, for use in a personal care appliance, for instance the power toothbrush of FIG. 1. The combined coil assembly 30 includes a single coil 32 which serves as both a charging coil for charging batteries 16 with

recharging circuit 34, and as an audio coil for the audio speaker.

Referring to FIGS. 2A and 2B, the combined coil assembly 30 includes an enclosure or bobbin 34 which typically is made from plastic and is mounted to the interior of the toothbrush. The coil/magnet arrangement in FIG. 2B is slightly modified relative to FIG. 2A. The enclosure in the embodiment shown is cylindrical, with a base portion 36 and a short peripheral wall 38. A permanent magnet 40 is positioned within the enclosure 34, bonded to the enclosure, as shown in FIG. 2B. Membrane 42 is mounted to the upper peripheral edge 44 of wall 38. Membrane 42 is a metallic film or a thin polymer film which is arranged to vibrate to produce a sound when activated. The diameter of the membrane can vary, typically up to 20 mm, with a desirable range of 10 12 mm.

Wound around magnet 40 as shown, with a space between the coil and the magnet, and mounted (bonded) to membrane 42 is a copper coil 32.

In the embodiment shown, coil 32 comprises 40 200 windings, depending upon the particular application. The respective ends of coil 32 terminate in electrical contacts 50 and 52. Electrical connections extend from contacts 50 and 52 to a recharging circuit 34 for the appliance batteries 16, and also are connected to microprocessor 56 which controls the operation of the toothbrush and produces the drive signals to drive the coil 32 in a manner to produce a desired sound. Coil 32 thus serves as both a charging coil for batteries 16 when the toothbrush is positioned in charger 20 and as an audio coil as part of a speaker assembly to produce desired audio sounds when the toothbrush is in use. All of the components for accomplishing both functions are contained within the single assembly 30.

When the toothbrush 10 is in the charging device, power is inductively transferred from a coil 60 in the conventional charger 20 to coil 32, and then to a charging circuit 34, which operates in known fashion to recharge the rechargeable batteries. The combined assembly is positioned within the power toothbrush so that the inductive coupling of power between coil 60 and coil 32 can occur in known fashion.

When the toothbrush 10 is in use, the microprocessor 56 will in the course of normal operation produce a drive signal for the speaker assembly to produce a desired sound, which could be a voice, music, or other audio. The drive signal from the microprocessor is applied through leads to contacts 50 and 52 of the coil 32, which produces a magnetic field which interacts with the magnetic field produced by magnet 40 to drive the membrane 42 to produce the desired audio sound.

In an alternative embodiment, shown in FIG. 3, a coil 70 is wound around the exterior of an enclosure/bobbin 72. A thin, flexible membrane 74 is mounted to the upper surface of the bobbin, with a permanent magnet 76 bonded to the interior surface of the membrane. A signal through the coil will cause the membrane to vibrate in normal speaker fashion to produce an audio sound.

In another embodiment, shown in FIG. 4, an enclosure bobbin 82 has a thin, flexible membrane 84 attached to the upper surface thereof. A permanent magnet 86 is bonded to the enclosure. A first coil 88 surrounds magnet 86 and is attached to the thin film membrane. A second coil 80 is wound around the exterior of enclosure bobbin 82, to accommodate higher charging currents from charger 20, if that is necessary in a particular appliance. However, second coil 80 is not necessary in the present arrangement.

Accordingly, a combined charging coil and audio coil assembly has been disclosed, which produces a combined function of a charging coil for an appliance and an audio coil for an audio speaker assembly. This has the advantage of reducing the number of components and overall space requirements within the power toothbrush.

Although a preferred embodiment of the invention has been disclosed for purposes of illustration, it should be understood that various changes, modifications and substitutions may be incorporated in the embodiment without departing from the spirit of the invention which is defined by the claims which follow.

1. A combined charge coil and audio speaker coil assembly in a personal care appliance, comprising: a single coil for inductively receiving charging current from a charger and for use in an audio speaker arrangement; an audio speaker membrane mounted to produce audio sounds when activated; a magnet for use in said audio speaker arrangement, wherein the single coil and the magnet are mounted such that the speaker membrane moves to produce an audible sound when a driving signal is applied to the coil; and contact members connected by leads to the coil for receiving said driving signal to move the membrane to produce an audio sound and also connected to a charging circuit for the rechargeable batteries (16).

2. The system of claim 1, including an enclosure bobbin for the coil and the magnet, having an open top portion, wherein the membrane is mounted to the top portion.

3. The system of claim 2, wherein the speaker magnet is surrounded by the coil and the coil is bonded to the membrane.

4. The system of claim 2, wherein the speaker magnet is surrounded by the coil, which is wound around the exterior of the enclosure bobbin, and the magnet is bonded to the membrane.

5. The system of claim 2, wherein the membrane is a thin metallic film.

6. The system of claim 2, wherein the membrane is a thin polymer film.

7. The system of claim 2, including a second coil (80) for accommodating increased charging current.

8. The system of claim 7, wherein the second coil surrounds the magnet and the first coil, the second coil being wound around the exterior surface of the enclosure bobbin, the magnet being bonded to the enclosure.

9. The system of claim 1, wherein the single coil comprises approximately 40 200 windings.

10. The system of claim 2, wherein the diameter of the membrane is within the range of 10 12 mm, and wherein the coil is approximately 4 mm in diameter and 5 mm long.
